(19) United States
(12) Patent Application Publication
(10) Pub. No.: US 2024/0298011 A1
(43) Pub. Date: Sep. 5, 2024

(54) METHOD AND APPARATUS FOR VIDEO ENCODING AND DECODING

(71) Applicant: InterDigital CE Patent Holdings, SAS, Paris (FR)

(72) Inventors: Karam Naser, Mouaze (FR); Fabrice Le Leannec, Betton (FR); Tangi Poirier, Thorigne-Fouillard (FR); Franck Galpin, Thorigne-Fouillard (FR)

(21) Appl. No.: 18/572,262

(22) PCT Filed: Jun. 15, 2022
(86) PCT No.: PCT/EP2022/066324

§ 371 Date: Dec. 20, 2023

(30) Foreign Application Priority Data
Jun. 24, 2021 (EP) 21305875.3

(51) Int. Cl. H04N 19/184

(52) U.S. Cl. CPC H04N 19/184

(57) ABSTRACT

At least a method and an apparatus are presented for efficiently encoding or decoding video wherein the signaling and/or the enabling of high bit depth process, for instance related to the transform skip coding mode or the entropy coding using rice parameter, are improved. For example, the method comprises obtaining video data, wherein the video data comprise at least one part of a coded picture, the coded picture being coded on a number of bits called bit depth, and determining whether the bit depth of the coded picture is larger than a level; and responsive to a determination that bit depth of the coded picture is larger than the level, obtaining from the video data, an information (sps_range_extension_flag) that indicates whether at least one parameter (sps_range_extension) related to high bit depth process is present in the video data for the coded picture.

### TECHNICAL FIELD

At least one of the present embodiments generally relates to a method or an apparatus for video encoding or decoding, and more particularly, to a method or an apparatus wherein the signaling and/or the enabling of a high bit depth process, for instance related to the transform skip coding mode or the entropy coding using rice parameter, are improved.

### BACKGROUND

To achieve high compression efficiency, image and video coding schemes usually employ prediction, including motion vector prediction, and transform to leverage spatial and temporal redundancy in the video content. Generally, intra or inter prediction is used to exploit the intra or inter frame correlation, then the differences between the original image and the predicted image, often denoted as prediction errors or prediction residuals, are transformed, quantized, and entropy coded. To reconstruct the video, the compressed data are decoded by inverse processes corresponding to the entropy coding, quantization, transform, and prediction.

At least some embodiments relate to improving compression efficiency compared to existing video compression systems such as HEVC (HEVC refers to High Efficiency Video Coding, also known as H.265 and MPEG-H Part 2 described in “ITU-T H.265 Telecommunication standardization sector of ITU (October 2014), series H: audiovisual and multimedia systems, infrastructure of audiovisual services-coding of moving video, High efficiency video coding, Recommendation ITU-T H.265”), or compared to VVC (Versatile video coding or H.266, described in “ITU-T H.266 Telecommunication standardization sector of ITU (August 2020), series H: audiovisual and multimedia systems, infrastructure of audiovisual services-coding of moving video”, a new standard developed by JVET, the Joint Video Experts Team). Recent additions to VVC video compression technology include support of high bit-depth, high bitrate and high frame rate coding, referred as Operation range extension. Existing methods for coding and decoding show some limitations in the high-level syntax signaling of VVC Operation range extension. Therefore, there is a need to improve the state of the art.

### SUMMARY

The drawbacks and disadvantages of the prior art are solved and addressed by the general aspects described herein.

According to a first aspect, there is provided a method. The method comprises video decoding by obtaining video data, wherein the video data comprise at least one part of a coded picture, the coded picture being coded on a number of bits called bit depth and determining whether the bit depth of the coded picture is larger than a level. Responsive to a determination that bit depth of the coded picture is larger than the level, the method further comprises obtaining from the video data, an information (sps_range_extension_flag) that indicates whether at least one parameter (sps_range_extension) related to high bit depth process is present in the video data for the coded picture.

According to another aspect, there is provided a second method. The method comprises video decoding by obtaining video data, wherein the video data comprise at least one part of a coded picture, the coded picture being coded on a number of bits called bit depth, and the video data further comprise at least one parameter (sps_range_extension) related to high bit depth process for the coded picture and determining whether the bit depth of the coded picture is larger than a level. Responsive to a determination that bit depth of the coded picture is larger than the level, the method further comprises obtaining any of the at least one parameter (sps_range_extension) related to high bit depth process for the coded picture.

According to another aspect, there is provided a third method. The method comprises video decoding by obtaining video data, wherein the video data comprise at least one part of a coded picture, the coded picture being coded on a number of bits called bit depth, and the video data further comprise at least one parameter (sps_range_extension) related to high bit depth process for the coded picture, determining whether to apply improved binary coding with rice parameter signaling or derivation based on the at least one parameter comprised in the video data and determining whether the bit depth of the coded picture is larger than a level. Responsive to a determination that bit depth of the coded picture is larger than the level and responsive that improved binary coding with rice parameter signaling or derivation is enabled, the method further comprises performing the decoding of the coded data by applying improved binary coding with rice parameter signaling or derivation.

According to another aspect, there is provided a fourth method. The method comprises video decoding by obtaining video data, wherein the video data comprise at least one part of a coded picture, the coded picture being coded on a number of bits called bit depth, and the video data further comprise at least one information (sps_range_extension_flag) that indicates whether at least one parameter (sps_range_extension) related to high bit depth process is present in the video data for the coded picture; wherein a conformance requirement specifies that responsive to a determination that bit depth of the coded picture is low than or equal to level, the information (sps_range_extension_flag) indicates that the at least one parameter (sps_range_extension) related to high bit depth process is not present in the video data for the coded picture.

According to another aspect, there is provided a fifth method. The method comprises encoding video data, wherein the video data comprise at least one part of a coded picture, the coded picture being coded on a number of bits called bit depth, and determining whether the bit depth of the coded picture is larger than a level. Responsive to a determination that bit depth of the coded picture is larger than the level, the method further comprises encoding into the video data, an information (sps_range_extension_flag) that indicates whether at least one parameter (sps_range_extension) related to high bit depth process is present in the video data for the coded picture.

According to another aspect, there is provided a sixth method. The method comprises encoding video data, wherein the video data comprise at least one part of a coded picture, the coded picture being coded on a number of bits called bit depth, and the video data further comprise at least one parameter (sps_range_extension) related to high bit depth process for the coded picture and determining whether the bit depth of the coded picture is larger than a level. Responsive to a determination that bit depth of the coded picture is larger than the level, the method further comprises encoding any of the at least one parameter (sps_range_extension) related to high bit depth process for the coded picture.

According to another aspect, there is provided a seventh method. The method comprises encoding video data, wherein the video data comprise at least one part of a coded picture, the coded picture being coded on a number of bits called bit depth, and the video data further comprise at least one parameter (sps_range_extension) related to high bit depth process for the coded picture, determining whether to apply improved binary coding with rice parameter signaling or derivation based on the at least one parameter comprised in the video data and determining whether the bit depth of the coded picture is larger than a level. Responsive to a determination that bit depth of the coded picture is larger than the level and responsive that improved binary coding with rice parameter signaling or derivation is enabled, the method further comprises performing the encoding of the coded data by applying improved binary coding with rice parameter signaling or derivation.

According to another aspect, there is provided an eighth method. The method comprises encoding video data, wherein the video data comprise at least one part of a coded picture, the coded picture being coded on a number of bits called bit depth, and the video data further comprise at least one information (sps_range_extension_flag) that indicates whether at least one parameter (sps_range_extension) related to high bit depth process is present in the video data for the coded picture; wherein a conformance requirement specifies that responsive to a determination that bit depth of the coded picture is low than or equal to a level, the information (sps_range_extension_flag) indicates that the at least one parameter (sps_range_extension) related to high bit depth process is not present in the video data for the coded picture.

According to another aspect, there is provided a ninth method. The method comprises encoding video data, wherein the video data comprise at least one part of a coded picture, the coded picture being coded on a number of bits called bit depth, and the video data further comprise at least one information (sps_range_extension_flag) that indicates whether at least one parameter (sps_range_extension) related to high bit depth process is present in the video data for the coded picture; wherein a conformance requirement specifies that responsive to a determination that bit depth of the coded picture is low than or equal to a level, the information (sps_range_extension_flag) indicates that the at least one parameter (sps_range_extension) related to high bit depth process is not present in the video data for the coded picture. According to another aspect, there is provided a tenth method. The method comprises decoding video data, wherein the video data comprise at least one part of a coded picture, the video data further comprise at least one parameter (sps_transform_skip_enabled_flag) related to enabling a transform skip process for the at least one part of the coded picture; wherein responsive to a determination that the transform skip is enabled, the method comprises obtaining at least one parameter (sps_ts_residual_coding_rice_present_in_sh_flag) specifying that at least one parameter (sh_ts_residual_coding_rice_idx_minus1) related to rice parameter used for residual coding is present in video data.

According to another aspect, there is provided an eleventh method. The method comprises encoding at least one part of a picture into video data, the video data further comprise at least one parameter (sps_transform_skip_enabled_flag) related to enabling a transform skip process for the at least one part of the coded picture; wherein responsive to a determination that the transform skip is enabled, the method further comprising encoding into the video data at least one parameter (sps_ts_residual_coding_rice_present_in_sh_flag) specifying that at least one parameter (sh_ts_residual_coding_rice_idx_minus1) related to rice parameter used for residual coding is present in video data.

According to another aspect, there is provided an apparatus. The apparatus comprises one or more processors, wherein the one or more processors are configured to implement the method for video decoding according to any of its variants. According to another aspect, the apparatus for video decoding comprises means for implementing the steps of the method for video decoding according to any of its variants.

According to another aspect, there is provided another apparatus. The apparatus comprises one or more processors, wherein the one or more processors are configured to implement the method for video decoding according to any of its variants. According to another aspect, the apparatus for video decoding comprises means for implementing the steps of the method for video decoding according to any of its variants.

According to another general aspect of at least one embodiment, there is provided a device comprising an apparatus according to any of the decoding embodiments; and at least one of (i) an antenna configured to receive a signal, the signal including the video block, (ii) a band limiter configured to limit the received signal to a band of frequencies that includes the video block, or (iii) a display configured to display an output representative of the video block.

According to another general aspect of at least one embodiment, there is provided a non-transitory computer readable medium containing data content generated according to any of the described encoding embodiments or variants.

According to another general aspect of at least one embodiment, there is provided a signal comprising video data generated according to any of the described encoding embodiments or variants.

According to another general aspect of at least one embodiment, a bitstream is formatted to include data content generated according to any of the described encoding embodiments or variants.

According to another general aspect of at least one embodiment, there is provided a computer program product comprising instructions which, when the program is executed by a computer, cause the computer to carry out any of the described encoding/decoding embodiments or variants.

These and other aspects, features and advantages of the general aspects will become apparent from the following detailed description of exemplary embodiments, which is to be read in connection with the accompanying drawings.

### BRIEF DESCRIPTION OF THE DRAWINGS

In the drawings, examples of several embodiments are illustrated.

FIG. 1 illustrates a generic decoding or encoding method according to an aspect of a first embodiment.

FIG. 2 illustrates a generic decoding or encoding method according to an aspect of a second embodiment.

FIG. 3 illustrates a generic decoding or encoding method according to an aspect of a third embodiment.

FIG. 4 illustrates a generic decoding or encoding method according to an aspect of a fifth embodiment.

FIG. 5 illustrates a block diagram of an embodiment of video encoder in which various aspects of the embodiments may be implemented.

FIG. 6 illustrates a block diagram of an embodiment of video decoder in which various aspects of the embodiments may be implemented.

FIG. 7 illustrates a block diagram of an example apparatus in which various aspects of the embodiments may be implemented.

FIGS. 8 and 9 illustrate a generic decoding or encoding method according to an aspect of a fourth embodiment.

### DETAILED DESCRIPTION

It is to be understood that the figures and descriptions have been simplified to illustrate elements that are relevant for a clear understanding of the present principles, while eliminating, for purposes of clarity, many other elements found in typical encoding and/or decoding devices. It will be understood that, although the terms first and second may be used herein to describe various elements, these elements should not be limited by these terms. These terms are only used to distinguish one element from another.

The various embodiments are described with respect to the encoding/decoding of an image. They may be applied to encode/decode a part of image, such as a slice or a tile, a tile group or a whole sequence of images.

Various methods are described above, and each of the methods comprises one or more steps or actions for achieving the described method. Unless a specific order of steps or actions is required for proper operation of the method, the order and/or use of specific steps and/or actions may be modified or combined.

At least some embodiments relate to method for encoding or decoding a video wherein the signaling and/or the enabling of high bit depth process, for instance related to the transform skip coding mode or the entropy coding using rice parameter, are improved.

The operation range extension of VVC is directed at improved coding for contents with high bit-depth, high bit-rate and/or high frame-rate. At least two technologies are adopted in VVC to support operation range extension. The first technology is the Extended Precision for transform coding as described by T. Zhou et al. in “CE-3.1 and CE-3.2: Transform coefficients range extension for high bit-depth coding” (JVET-V0047, Joint Video Experts Team (JVET) of ITU-T SG 16 WP 3 and ISO/IEC JTC 1/SC 29 22nd Meeting, by teleconference, 20-28 Apr. 2021). In current VVC design, the transform coefficients are limited to 15 bits signed integer for a signal of 10's bit depth. The first technology proposes to extend the bit depth of transform coefficients to Bit-depth+6. The second technology is an improved binary coding with rice parameter signaling and derivation as described by Hong-Jheng Jhu et al. in “CE-2.1: Slice based Rice parameter selection for transform skip residual coding” (JVET-V0054. Joint Video Experts Team (JVET) of ITU-T SG 16 WP 3 and ISO/IEC JTC 1/SC 29 22nd Meeting, by teleconference, 20-28 Apr. 2021) and by Dmytro Rusanovskyy et al. in “CE-related: On history-enhanced method of Rice parameter derivation for regular residual coding (RRC) at high bit depths” (JVET-V0106, Joint Video Experts Team (JVET) of ITU-T SG 16 WP 3 and ISO/IEC JTC 1/SC 29 22nd Meeting, by teleconference, 20-28 Apr. 2021).

In the latest development of VVC operation range extensions (“VVC operation range extensions (Draft 3)” by Frank Bossen et al., JVET-V2005, Joint Video Experts Team (JVET) of ITU-T SG 16 WP 3 and ISO/IEC JTC 1/SC 29 22nd Meeting, by teleconference, 20-28 Apr. 2021), the new tools are signaled with specific sequence parameters set (SPS) defined under the syntax structure (sps_range_extension( ) as follows:

| | Descriptor |
|---|---|
| sps_range_extension( ) { | |
| extended_{—}precision_{—}processing_{—}flag | u(1) |
| sps_{—}ts_{—}residual_{—}coding_{—}rice_{—}present_{—}in_{—}sh_{—}flag | u(1) |
| sps_{—}rrc_{—}rice_{—}extension_{—}flag | u(1) |
| sps_{—}persistent_{—}rice_{—}adaptation_{—}enabled_{—}flag | u(1) |
| } | |

Where the flag extended_precision_processing_flag is used to enable or disable the extended precision for transform coefficients. Namely, extended_precision_processing_flag equal to 1 specifies that an extended dynamic range may be used for transform coefficients and transform processing. extended_precision_processing_flag equal to 0 specifies that the extended dynamic range is not used. When not present, the value of extended_precision_processing_flag is inferred to be equal to 0.

And, where the flags sps_ts_residual_coding_rice_present_in_sh_flag, sps_rrc_rice_extension_flag, and sps_persistent_rice_adaptation_enabled_flag are used in the improved entropy coding tool to define some parameters that are further described hereafter.

sps_ts_residual_coding_rice_present_in_sh_flag equal to 1 specifies that sh_ts_residual_coding_rice_idx_minus1 may be present in slice_header( ) syntax structures referring to the SPS. sps_ts_residual_coding_rice_present_in_sh_flag equal to 0 specifies that sh_ts_residual_coding_rice_idx_minus1 is not present in slice_header( ) syntax structures referring to the SPS. When not present, the value of sps_ts_residual_coding_rice_present_in_sh_flag is inferred to be equal to 0.

sps_rrc_rice_extension_flag equal to 1 specifies that an extension of Rice parameter derivation for the binarization of abs_remaining[ ] and dec_abs_level[ ] is enabled. sps_rrc_rice_extension_flag equal to 0 specifies that the extension of Rice parameter derivation for the binarization of abs_remaining[ ] and dec_abs_level[ ] is disabled. When not present, the value of sps_rrc_rice_extension_flag is inferred to be equal to 0.

sps_persistent_rice_adaptation_enabled_flag equal to 1 specifies that Rice parameter derivation for the binarization of abs_remainder[ ] and dec_abs_level[ ] is initialized at the start of each TU using statistics accumulated from previous TUs. sps_persistent_rice_adaptation_enabled_flag equal to 0 specifies that no previous TU state is used in Rice parameter derivation. When not present, the value of sps_persistent_rice_adaptation_enabled_flag is inferred to be equal to 0.

This syntax structure (sps_range_extension) is signaled only when the SPS flag for VVC extension flag (sps_extension_flag) and the SPS flag for VVC range extension flag (sps_range_extension_flag) are equal to one as shown (bold) in the table below:

| | |
|---|---|
| if( sps_{—}extension_{—}flag ) { | |
| sps_{—}range_{—}extension_{—}flag | u(1) |
| sps_extension_7bits | u(7) |
| if( sps_{—}range_{—}extension_{—}flag ) | |
| sps_{—}range_{—}extension( ) | |
| } | |
| if( sps_extension_7bits ) | |
| while( more_rbsp_data( ) ) | |
| sps_extension_data_flag | u(1) |
| rbsp_trailing_bits( ) | |

It should be noted that both the extended precision and the improved entropy coding target high bit-depth coding, i.e., sequences with bit-depth higher than 10, such extension is referred to as “range extension” and signaled by the related flag “sps_range_extension_flag”.

The latest version of the specification “VVC operation range extensions” further described the decoding process of the above-mentioned flags, the parameters used in such decoding of the coded data.

According to a first variant related to the extended precision for transform coefficients (extended_precision_processing_flag), the section “7.4.3.22 Sequence parameter set range extension semantics” specifies that the variable ExtendedPrecisionFlag is used in the transform coding of coefficients and processed as follows (highlight in bold).

The variable ExtendedPrecisionFlag is derived as follows:
If extended_precision_processing_flag is equal to 1 and BitDepth is greater than 10, ExtendedPrecisionFlag is set equal to 1.
Otherwise (extended_precision_processing_flag is equal to 0 or BitDepth is less than or equal to 10), ExtendedPrecisionFlag is set equal to 0.

The variable Log 2TransformRange is derived as follows:

Log 2Transform Range=ExtendedPrecisionFlag? Max(15, Min(20,BitDepth+6)):15

CoeffMin=−(1<<(ExtendedPrecisionFlag? Max(15, Min(20,BitDepth+6)):15))

CoeffMax=(1<<(ExtendedPrecisionFlag? Max(15, Min(20,BitDepth+6)):15))−1

That is, when BitDepth is equal or less than 10, no extension of the transform coefficient is performed regardless of the value of extended_precision_processing_flag.

According to a second variant related to the Slice based Rice parameter selection for transform skip residual coding (sps_ts_residual_coding_rice_present_in_sh_flag), the same section 7.4.3.22 specifies (highlighted in bold) the derivation of the variable sh_ts_residual_coding_rice_idx_minus1 in the slice header:

| | |
|---|---|
| if( sps_transform_skip_enabled_flag && | |
| !sh_dep_quant_used_flag && | |
| !sh_sign_data_hiding_used_flag ) | |
| sh_ts_residual_coding_disabled_flag | u(1) |
| if( !sh_{—}ts_{—}residual_{—}coding_{—}disabled_{—}flag && | |
| sps_{—}ts_{—}residual_{—}coding_{—}rice_{—}present_{—}in_{—}sh_{—}flag ) | |
| sh_{—}ts_{—}residual_{—}coding_{—}rice_{—}idx_{—}minus1 | u(3) |
| if( pps_slice_header_extension_present_flag ) { | |
| sh_slice_header_extension_length | ue(v) |

Where the variable sh_ts_residual_coding_rice_idx_minus1 specifies the rice parameter used for the residual_ts_coding( ) syntax structure as detailed in the semantics, section 9.3.3.11:

If transform_skip_flag[x0][y0][cIdx] is equal to 1 and sh_ts_residual_coding_disabled_flag is equal to 0, the Rice parameter cRiceParam is set equal to sh_ts_residual_coding_rice_idx_minus1+1.

That is, the rice parameter index is independent from the bit-depth, although it is designed for bit-depth higher than 10.

According to a third variant related to the rice parameter derivation for regular residual coding (RRC) at high bit depths (sps_rrc_rice_extension_flag), the sections 9.3.3.2 and 9.3.3.11 specify (highlighted in bold) the derivation of the variables Shiftval and BaseLevel, also used in Rice parameter derivation.

In section 9.3.3.2, the value of the variable shiftVal is then derived as follows:

```
if( !sps_{—}rrc_{—}rice_{—}extension_{—}flag)
  shiftVal = 0
else
  shiftVal = ( localSumAbs < Tx[ 0 ] ) ? Rx[ 0 ] : ( ( localSumAbs < Tx[ 1 ] ) ? Rx[ 1 ] :
    ( ( localSumAbs < Tx[ 2 ] ) ? Rx[ 2 ] : ( ( localSumAbs < Tx[ 3 ] ) ? Rx[ 3 ] : Rx[4]
) ) )
```

Besides, in section 9.3.3.11, the variable baseLevel is derived as follows:
If sps_rrc_rice_extension_flag is equal to 0, baseLevel is set equal to 4.
Otherwise (sps_rrc_rice_extension_flag is equal to 1), the following applies:

baseLevel=(BitDepth>12)?((sh_slice_type==|)?1:2):((sh_slice_type==|)?2:3)

Similar to sps_ts_residual_coding_rice_present_in_sh_flag, the rrc rice extension is also independent from the input bit-depth.

According to a fourth variant related to the rice parameter derivation for regular residual coding (RRC) at high bit depths (sps_persistent_rice_adaptation_enabled_flag), the section 9.3.3.1 specifies the initialization of some context variables at the start of each TU using statistics accumulated from previous TUs according to the following (highlighted in bold).

The context variables of the arithmetic decoding engine are initialized as follows:
If the CTU is the first CTU in a slice or tile, the initialization process for context variables is invoked as specified in clause 9.3.2.2 and the array PredictorPaletteSize[chType], with chType=0, 1, is initialized to 0, and the following applies:
If sps_persistent_rice_adaptation_enabled_flag is equal to 0, the values of StatCoeff[idx] for idx ranging from 0 to 2, inclusive, are initialized to be equal to 0.
Otherwise the following applies:

$$StatCoeff [ idx ] = ( bitDepth > 10 ) ? ( 2 * Floor ( Log 2 ( bitDepth - 10 ) ) : 0$$

This tool is thus dependent on bitDepth. When bitDepth is less than or equal to 10, the persistent rice adaptation is deactivated regardless of its SPS flag sps_persistent_rice_adaptation_enabled_flag.

Thus, the current design of VVC operation range extensions presents both inconsistency in the HLS design as well as in undesirable behavior for bitDepth being less than or equal to 10 and combination of the four SPS flags corresponding to operation range extension. For instance, the signaling of both extended_precision_processing_flag and sps_persistent_rice_adaptation_enabled_flag may be redundant as the tools are not used according to the decoding process. For instance, Inappropriate behavior when sps_ts_residual_coding_rice_present_in_sh_flag and sps_rrc_rice_extension_flag are activated as they are only developed for bitDepth higher than 10. More generally, even if one of the flags indicates that a tool is activated, the same tool may not be applied by the decoding process on some other condition. Besides, sps_ts_residual_coding_rice_present_in_sh_flag is signaled regardless of transform skip SPS flag (sps_transform_skip_enabled_flag). This means that even when transform skip is disabled (sps_transform_skip_enabled_flag=0), sps_ts_residual_coding_rice_present_in_sh_flag is still signaled in redundant manner as it cannot be used with transform skip being enabled.

Advantageously, the present principles disclose disabling all the tools for VVC operation range extension when the internal bit-depth is less than or equal to 10, and also disabling sps_ts_residual_coding_rice_present_in_sh_flag when transform skip is disabled.

This is solved and addressed by the general aspects described herein, which are directed to signaling and/or enabling of high bit depth process, for instance related to the transform skip coding mode or the entropy coding using rice parameter.

### Various Embodiments of the Generic Encoding or Decoding Method are Described in the Following

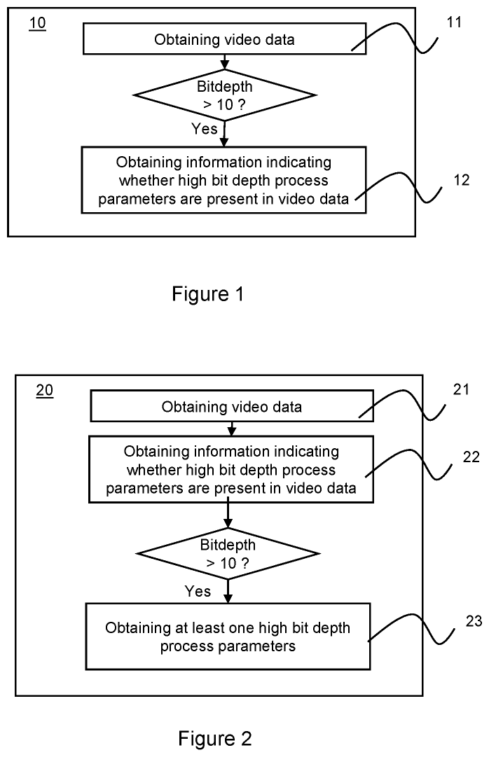

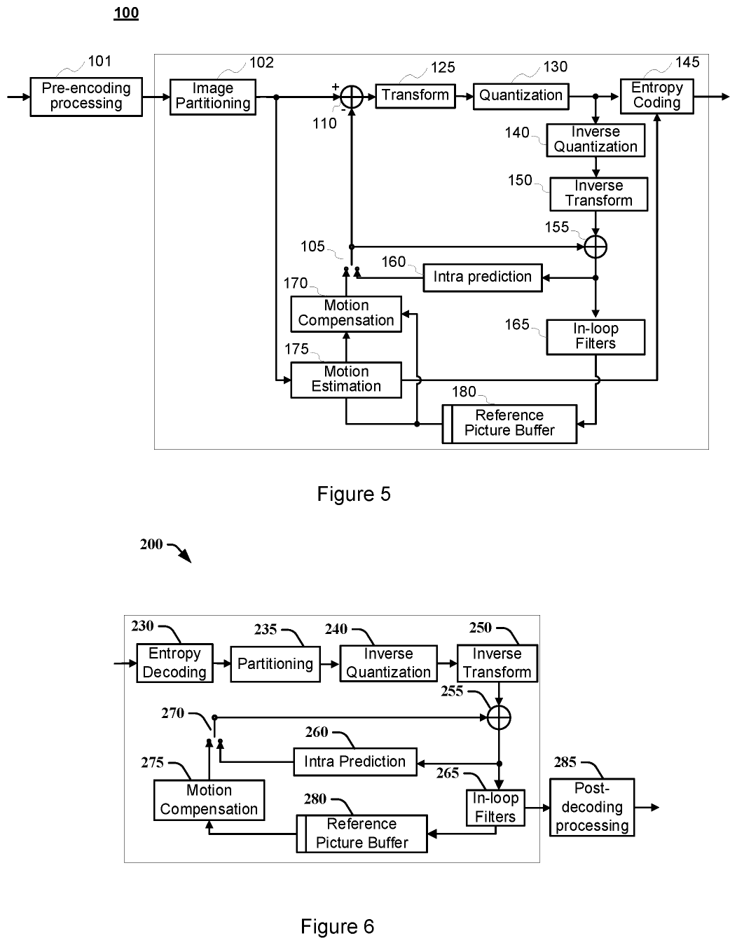

FIG. 1 illustrates a generic decoding or encoding method according to an aspect of a first embodiment. The block diagram of FIG. 1 partially represents modules of a decoder or decoding method, for instance implemented in the exemplary decoder of FIG. 6. The block diagram of FIG. 1 may also partially represent modules of an encoder or encoding method, for instance implemented in the exemplary encoder of FIG. 5.

According to the first embodiment, the SPS flag sps_range_extension_flag is conditionally signaled according to the value of bitDepth. That is, it is signaled only if (bitDepth>10), otherwise it is inferred as zero. By doing so, the 4 SPS flags of the operation range extension will only be signaled when (bitDepth>10) and (sps_range_extension_flag=1). The corresponding specification change in the “VVC operation range extensions” is highlighted below (underlined for added part and strikethrough for removed part):

| | |
|---|---|
| if( sps_extension_flag ) { | |
| if (bitDepth > 10){ | |
| sps_{—}range_{—}extension_{—}flag | u(1) |
| } | |
| sps_{—}extension_{—}7bits | u(7) |
| if( sps_range_extension_flag ) | |
| sps_range_extension( ) | |
| } | |
| if( sps_extension_7bits ) | |
| while( more_rbsp_data( ) ) | |
| sps_extension_data_flag | u(1) |
| rbsp_trailing_bits( ) | |

### 7.4.3.22 Sequence Parameter Set Range Extension Semantics

extended_precision_processing_flag equal to 1 specifies that an extended dynamic range may be used for transform coefficients and transform processing.

extended_precision_processing_flag equal to 0 specifies that the extended dynamic range is not used. When not present, the value of extended_precision_processing_flag is inferred to be equal to 0.

The variable ExtendedPrecisionFlag is derived as follows:
If extended_precision_processing_flag is equal to 1, ExtendedPrecisionFlag is set equal to 1.
Otherwise (extended_precision_processing_flag is equal to 0), ExtendedPrecisionFlag is set equal to 0.

The variable Log 2TransformRange is derived as follows:

$$Log 2 TransformRange = ExtendedPrecisionFlag ? Max ( 15 , Min ( 20 , BitDepth + 6 ) ) : 15$$

The context variables of the arithmetic decoding engine are initialized as follows:
If the CTU is the first CTU in a slice or tile, the initialization process for context variables is invoked as specified in clause 9.3.2.2 and the array PredictorPaletteSize[chType], with chType=0, 1, is initialized to 0, and the following applies:
   If sps_persistent_rice_adaptation_enabled_flag is equal to 0, the values of StatCoeff[idx] for idx ranging from 0 to 2, inclusive, are initialized to be equal to 0.
   Otherwise the following applies:

StatCoeff[idx]= [symbol] 2*Floor(Log 2(bitDepth−10) [symbol] (X)

The first embodiment advantageously removes redundancy as well as simplifies the decoding process as bitDepth is not checked.

Thus, the method 10, when representing a decoding method, comprises obtaining 11 video data, wherein the video data comprise at least one part of a coded picture, the coded picture being coded on a number of bits called bit depth, and determining whether the bit depth of the coded picture is larger than a level. According to a non-limiting example, the level is set to 10 bit depth as specified in the current VVC range extension specification. Responsive to the determination that bit depth of the coded picture is larger than the level, ie 10 (yes), the method further comprises obtaining 12 from the video data, an information (sps_range_extension_flag) that indicates whether at least one parameter (sps_range_extension) related to high bit depth process is present in the video data for the coded picture.

According to another feature not represented on FIG. 1, the method further comprises determining that the at least one parameter (sps_range_extension) related to high bit depth process is present in the video data for the coded picture; and responsive to a determination that the at least one parameter related to high bit depth process is present, performing the decoding of the coded data by applying the high depth process based on the at least one parameter related to high bit depth process.

According to a variant, the high bit depth process comprises an extension of the bit depth of transform coefficients as detailed above. According to anther variant, the high bit depth process comprises an improved binary coding with rice parameter signaling or derivation as detailed above.

Besides, the method 10, when representing an encoding method, comprises encoding 11 at least one part of a picture video data, the coded picture being coded on a number of bits called bit depth, and determining whether the bit depth of the coded picture is larger than 10.

Responsive to the determination that bit depth of the coded picture is larger than 10 (yes), the method further comprises encoding 12 into the video data, an information (sps_range_extension_flag) that indicates whether at least one parameter (sps_range_extension) related to high bit depth process is present in the video data for the coded picture.

FIG. 2 illustrates a generic decoding or encoding method according to an aspect of a second embodiment. The block diagram of FIG. 2 partially represents modules of a decoder or decoding method, for instance implemented in the exemplary decoder of FIG. 6. The block diagram of FIG. 2 may also partially represent modules of an encoder or encoding method, for instance implemented in the exemplary encoder of FIG. 5.

According to the second embodiment, each SPS flag related to high bit depth coding is signaled depending on the input bit-depth. This makes the signaling more flexible as sps_range_extension_flag can be signaled regardless of the bit-depth and the SPS of the high bit-depth tools are signaled only the input bit-depth is higher than 10.

The following changes are proposed:

| | Descriptor |
|---|---|
| sps_range_extension( ) { | |
| if (bitDepth > 10){ | |
| extended_{—}precision_{—}processing_{—}flag | u(1) |
| } | |
| if (bitDepth > 10){ | |
| sps_{—}ts_{—}residual_{—}coding_{—}rice_{—}present_{—}in_{—}sh_{—}flag | u(1) |
| } | |
| if (bitDepth > 10){ | |
| sps_{—}rrc_{—}rice_{—}extension_{—}flag | u(1) |
| } | |
| if (bitDepth > 10){ | |
| sps_{—}persistent_{—}rice_{—}adaptation_{—}enabled_{—}flag | u(1) |
| } | |
| } | |

The changes to the decoding process is the same as in the first embodiment.

A subset of this modification can be considered. For example, only the SPS related to extended precision flag and persistent rice parameter adaptation are conditionally coded. The advantage is that these tools would be restricted to only high bit-depth coding, while the rest are also allowed for high bit-rate and high frame-rate coding, even for low bit-depth input. The corresponding changes are:

| | Descriptor |
|---|---|
| sps_range_extension( ) { | |
| if (bitDepth > 10){ | |
| extended_{—}precision_{—}processing_{—}flag | u(1) |
| } | |
| sps_{—}ts_{—}residual_{—}coding_{—}rice_{—}present_{—}in_{—}sh_{—}flag | u(1) |
| sps_{—}rrc_{—}rice_{—}extension_{—}flag | u(1) |
| if (bitDepth > 10){ | |
| sps_{—}persistent_{—}rice_{—}adaptation_{—}enabled_{—}flag | u(1) |
| } | |
| } | |

In both cases, the changes to the decoding process is the same as in the first embodiment.

The first embodiment advantageously removes redundancy as well as simplifies the decoding process as bitDepth is not checked.

Thus, the method 20, when representing a decoding method, comprises obtaining 21 video data, wherein the video data comprise at least one part of a coded picture, the coded picture being coded on a number of bits called bit depth, and the video data further comprise at least one parameter (sps_range_extension) related to high bit depth process for the coded picture. The method then comprises determining whether the bit depth of the coded picture is larger than 10. Responsive to the determination that bit depth of the coded picture is larger than 10 (yes), the method further comprises obtaining 23 any of the at least one parameter (sps_range_extension, or separately extended_precision_processing_flag, . . . ) related to high bit depth process for the coded picture. According to another optional feature, the method comprises obtaining 22 an information (sps_range_extension_flag) that indicates whether at least one parameter (sps_range_extension) related to high bit depth process is present in the video data for the coded picture. According to another feature not represented on FIG. 2, the method further performing the decoding of the coded data by applying the high depth process based on the at least one parameter related to high bit depth process.

According to a variant, the high bit depth process comprises an extension of the bit depth of transform coefficients as detailed above. According to anther variant, the high bit depth process comprises an improved binary coding with rice parameter signaling or derivation as detailed above.

Besides, the method 20, when representing an encoding method, comprises encoding 21 at least one part of a picture video data, the coded picture being coded on a number of bits called bit depth, and optionally encoding 22 an information (sps_range_extension_flag) that indicates whether at least one parameter (sps_range_extension) related to high bit depth process is present in the video data for the coded picture. The encoding method then determines whether the bit depth of the coded picture is larger than 10. Responsive to the determination that bit depth of the coded picture is larger than 10 (yes), the method further comprises encoding 23 into the video data, at least one parameter (sps_range_extension, or separately extended_precision_processing_flag, . . . ) related to high bit depth process in the video data.

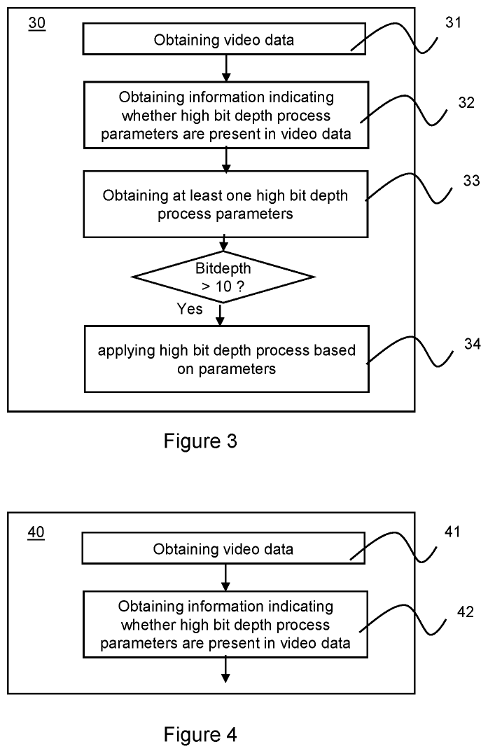

FIG. 3 illustrates a generic decoding or encoding method according to an aspect of a third embodiment. The block diagram of FIG. 3 partially represents modules of a decoder or decoding method, for instance implemented in the exemplary decoder of FIG. 6. The block diagram of FIG. 3 may also partially represent modules of an encoder or encoding method, for instance implemented in the exemplary encoder of FIG. 5.

According to a third embodiment, instead of SPS modification, the two tools, the rice parameter index and the rrc rice extension, corresponding to the SPS flags (sps_ts_residual_coding_rice_present_in_sh_flag and sps_rrc_rice_extension_flag) are disabled during the decoding process of high bit-depth data. Specifically, the following change in the “VVC operation range extensions” is proposed:

In section 9.3.3.11:

If transform_skip_flag[x0][y0][cIdx] is equal to 1 and sh_ts_residual_coding_disabled_flag is equal to 0 and BitDepth is greater than 10, the Rice parameter cRiceParam is set equal to sh_ts_residual_coding_rice_idx_minus1+1.

And in section 9.3.3.2

The value of the variable shiftVal is derived as follows:

if( !sps_rrc_rice_extension_flag || BitDepth <= 10 )

| | |
|---|---|
| shiftVal = 0 | (X) |

```
else
  shiftVal = ( localSumAbs < Tx[ 0 ] ) ? Rx[ 0 ] : ( ( localSumAbs < Tx[ 1 ] ) ? Rx[ 1 ] :
  ( ( localSumAbs < Tx[ 2 ] ) ? Rx[ 2 ] : ( ( localSumAbs < Tx[ 3 ] ) ? Rx[ 3 ] : Rx[4] ) ) )
```

Although this embodiment does not remove the redundant signaling, but it advantageously eliminates the undesired behavior that high bit-depth tools are activated for bit-depth less than or equal to 10.

Thus, the method 30, when representing a decoding method, comprises obtaining 31 video data, wherein the video data comprise at least one part of a coded picture, the coded picture being coded on a number of bits called bit depth, and the video data further comprise at least one parameter (sps_range_extension) related to high bit depth process for the coded picture.

Then the method comprises obtaining 32 an information (sps_range_extension_flag) that indicates whether at least one parameter (sps_range_extension) related to high bit depth process is present in the video data for the coded picture. The method responsively comprises obtaining 33 any of the at least one parameter (sps_range_extension, or separately extended_precision_processing_flag, . . . ) related to high bit depth process for the coded picture. Then, the method comprises determining whether the bit depth of the coded picture is larger than 10. Responsive to the determination that bit depth of the coded picture is larger than 10 (yes), the method further performing the decoding of the coded data by applying the high depth process based on the at least one parameter related to high bit depth process.

According to a variant, the high bit depth process comprises an extension of the bit depth of transform coefficients as detailed above. According to anther variant, the high bit depth process comprises an improved binary coding with rice parameter signaling or derivation as detailed above.

Besides, the method 30, when representing an encoding method, comprises encoding 31 at least one part of a picture video data, the coded picture being coded on a number of bits called bit depth, and optionally encoding 32 an information (sps_range_extension_flag) that indicates whether at least one parameter (sps_range_extension) related to high bit depth process is present in the video data for the coded picture, and encoding 33 at least one parameter (sps_range_extension, or separately extended_precision_processing_flag, . . . ) related to high bit depth process in the video data. The encoding method then determines whether the bit depth of the coded picture is larger than 10. Responsive to the determination that bit depth of the coded picture is larger than 10 (yes), the method further comprises encoding the video data by applying the high depth process based on the at least one parameter related to high bit depth process.

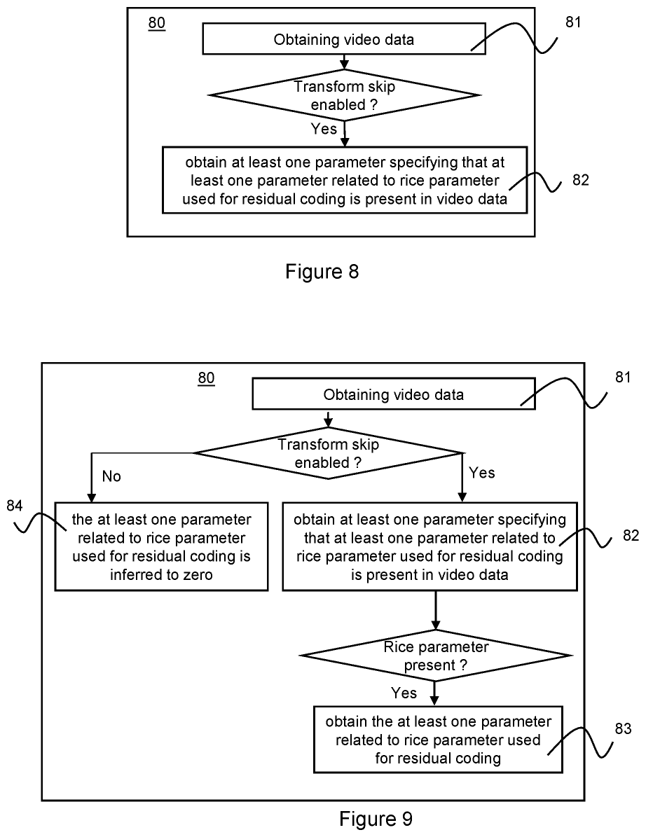

FIGS. 8 and 9 illustrate a generic decoding or encoding method according to an aspect of a fourth embodiment. The block diagram of FIGS. 8 and 9 partially represents modules of a decoder or decoding method, for instance implemented in the exemplary decoder of FIG. 6. The block diagram of FIGS. 8 and 9 may also partially represent modules of an encoder or encoding method, for instance implemented in the exemplary encoder of FIG. 5. For sake of conciseness, the decoding process is described with FIGS. 8 and 9.

According to a fourth embodiment, the SPS flag sps_ts_residual_coding_rice_present_in_sh_flag is conditionally signaled only if transform skip is enabled (sps_transform_skip_enabled_flag=1), otherwise it is inferred to zero. The corresponding specification in the “VVC operation range extensions” is highlighted below (underlined for added part):

| | Descriptor |
|---|---|
| sps_range_extension( ) { | |
| extended_{—}precision_{—}processing_{—}flag | u(1) |
| if (sps transform skip enabled flag){ | |
| sps_{—}ts_{—}residual_{—}coding_{—}rice_{—}present_{—}in_{—}sh_{—}flag | u(1) |
| } | |
| sps_{—}rrc_{—}rice_{—}extension_{—}flag | u(1) |
| sps_{—}persistent_{—}rice_{—}adaptation_{—}enabled_{—}flag | u(1) |
| } | |

Where the followings semantics are used:

sps_transform_skip_enabled_flag equal to 1 specifies that transform_skip_flag could be present in the transform unit syntax. sps_transform_skip_enabled_flag equal to 0 specifies that transform_skip_flag is not present in the transform unit syntax.

transform_skip_flag[x0][y0][cIdx] specifies whether a transform is applied to the associated transform block or not.

As illustrated on FIG. 8, video data comprising at least one part of a coded picture to decode is obtained in a step 81. After prediction process, prediction residuals are calculated. The prediction residuals are then entropy decoded, Parameters are used to determine the residual decoding process to apply, for example using the transform skip (residual_ts_coding). According to an embodiment, at least one parameter (sps_transform_skip_enabled_flag) related to enabling a transform skip process for the at least one part of the coded picture is tested. In case (YES), the transform skip process is enabled (sps_transform_skip_enabled_flag is equal to one) then in 82, the Slice based Rice parameter selection for transform skip residual coding of the VVC operation range extension is enabled, In other words, a syntax element (sps_ts_residual_coding_rice_present_in_sh_flag) specifies whether further Slice based Rice parameters used for transform skip residual coding are present in video data.

As further shown on FIG. 9, in case (YES), the syntax element (sps_ts_residual_coding_rice_present_in_sh_flag is equal to one) specifies that improved binary coding with rice parameters (are signaled for the coded picture, then the parameters are decoded in a step 83 from the video data and the residual decoded accordingly. In case (NO) the syntax element (sps_ts_residual_coding_rice_present_in_sh_flag is equal to zero), the improved binary coding of the VVC operation range extension is not enabled and parameters not signaled within video data.

Besides, In case (NO), the transform skip process is not enabled (sps_transform_skip_enabled_flag is equal to zero) then in 84, the syntax element sps_ts_residual_coding_rice_present_in_sh_flag is inferred to zero.

Advantageously the fourth embodiment is compatible with any of the first, second and third embodiment. Accordingly, a syntax element (sps_transform_skip_enabled_flag) is tested to determine whether the transform skip is enabled and responsive to the determination that the transform skip is enabled, obtain one of the at least one parameter (sps_ts_residual_coding_rice_present_in_sh_flag) related to improved binary coding with rice parameter signaling for the coded picture.

FIG. 4 illustrates a generic decoding or encoding method according to an aspect of a fifth embodiment. The block diagram of FIG. 4 partially represents modules of a decoder or decoding method, for instance implemented in the exemplary decoder of FIG. 6. The block diagram of FIG. 4 may also partially represent modules of an encoder or encoding method, for instance implemented in the exemplary encoder of FIG. 5.

According to a fifth embodiment, an additional constraint is used on the values of the SPS flags. Specifically, when the bit depth is less than or equal to 10, constraints are made such that all other SPS flags related to high bit depth coding are set to zero. Advantageously, this embodiment avoids modifying the specification (syntax or decoding) related to VVC operation range extensions.

According to the fifth embodiment, the following conformance constraint is added:
“It is a requirement of bitstream conformance that sps range extension flag must be zero when BitDepth is less than or equal to 10”

According to a variant of the fifth embodiment, four conformance constraints are added for all the SPS flag related to high bit-depth coding as follows:
“It is a requirement of bitstream conformance that extended precision processing flag must be zero when BitDepth is less than or equal to 10
It is a requirement of bitstream conformance that sps ts residual coding rice present in sh flag must be zero when BitDepth is less than or equal to 10
It is a requirement of bitstream conformance that sps rrc rice extension flag must be zero when BitDepth is less than or equal to 10
It is a requirement of bitstream conformance that sps persistent rice adaptation enabled flag must be zero when BitDepth is less than or equal to 10”

Similarly, according to another variant embodiment, the flag related to the improved binary coding with rice parameter signaling sps_ts_residual_coding_rice_present_in_sh_flag is set to zero when the transform skip is disabled, that is when the flag sps_transform_skip_enabled_flag is equal to zero:
“It is a requirement of bitstream conformance that sps ts residual coding rice present in sh flag must be zero when sps ts residual coding rice present in sh flag is equal to zero”

Advantageously, the fifth embodiment requires the minimal change to the existing specification text and decoder implementation, and still solves the problem of undesired behavior. However, the fifth embodiment does not reduce the signaling of the redundant information.

Thus, the method 40, when representing a decoding method, comprises obtaining 41 video data, wherein the video data comprise at least one part of a coded picture, the coded picture being coded on a number of bits called bit depth, and the video data further comprise at least one parameter (sps_range_extension) related to high bit depth process for the coded picture. Then the method comprises obtaining 42 an information (sps_range_extension_flag) that indicates whether at least one parameter (sps_range_extension) related to high bit depth process is present in the video data for the coded picture. The method may then responsively comprise obtaining any of the at least one parameter (sps_range_extension, or separately extended_precision_processing_flag, . . . ) related to high bit depth process for the coded picture and performing the decoding of the coded data by applying the high depth process based on the at least one parameter related to high bit depth process.

No additional test on bit-depth is performed in the decoding or encoding method as a conformance requirement specifies that responsive to a determination that bit depth of the coded picture is low than or equal to 10, the information (sps_range_extension_flag) indicates that the at least one parameter (sps_range_extension) related to high bit depth process is not present in the video data for the coded picture and thus the high bit depth process is disabled.

### Additional Embodiments and Information

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

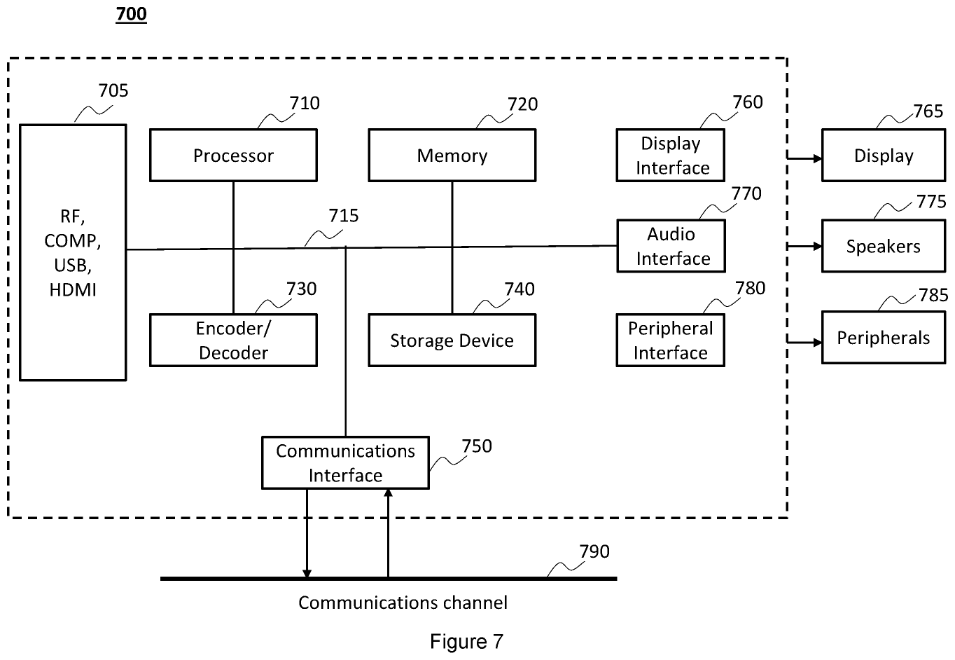

The aspects described and contemplated in this application can be implemented in many different forms. FIG. 5, FIG. 6 and FIG. 7 below provide some embodiments, but other embodiments are contemplated and the discussion of FIG. 5, FIG. 6 and FIG. 7 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various methods and other aspects described in this application can be used to modify modules, for example, the transform modules, and/or inverse transform modules, the entropy coding module, entropy decoding (160, 260, 125, 150, 250, 145, 230), of a video encoder 100 and decoder 200 as shown in FIG. 4 and FIG. 5. Moreover, the present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

Various numeric values are used in the present application, for example, the number of transforms, the number of transform level, the indices of transforms. The specific values are for example purposes and the aspects described are not limited to these specific values.

FIG. 5 illustrates an encoder 100. Variations of this encoder 100 are contemplated, but the encoder 100 is described below for purposes of clarity without describing all expected variations.

Before being encoded, the video sequence may go through pre-encoding processing (101), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

In the encoder 100, a picture is encoded by the encoder elements as described below. The picture to be encoded is partitioned (102) and processed in units of, for example, CUs. Each unit is encoded using, for example, either an intra or inter mode. When a unit is encoded in an intra mode, it performs intra prediction (160). In an inter mode, motion estimation (175) and compensation (170) are performed. The encoder decides (105) which one of the intra mode or inter mode to use for encoding the unit, and indicates the intra/inter decision by, for example, a prediction mode flag. Prediction residuals are calculated, for example, by subtracting (110) the predicted block from the original image block.

The prediction residuals are then transformed (125) and quantized (130). The quantized transform coefficients, as well as motion vectors and other syntax elements, are entropy coded (145) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture to perform, for example, deblocking/SAO (Sample Adaptive Offset) filtering to reduce encoding artifacts. The filtered image is stored at a reference picture buffer (180).

FIG. 6 illustrates a block diagram of a video decoder 200. In the decoder 200, a bitstream is decoded by the decoder elements as described below. Video decoder 200 generally performs a decoding pass reciprocal to the encoding pass as described in FIG. 5. The encoder 100 also generally performs video decoding as part of encoding video data. In particular, the input of the decoder includes a video bitstream, which can be generated by video encoder 100. The bitstream is first entropy decoded (230) to obtain transform coefficients, motion vectors, and other coded information. The picture partition information indicates how the picture is partitioned. The decoder may therefore divide (235) the picture according to the decoded picture partitioning information. The transform coefficients are de-quantized (240) and inverse transformed (250) to decode the prediction residuals. Combining (255) the decoded prediction residuals and the predicted block, an image block is reconstructed. The predicted block can be obtained (270) from intra prediction (260) or motion-compensated prediction (i.e., inter prediction) (275). In-loop filters (265) are applied to the reconstructed image. The filtered image is stored at a reference picture buffer (280). The decoded picture can further go through post-decoding processing (285), for example, an inverse color transform (e.g. conversion from YCbCr 4:2:0 to RGB 4:4:4) or an inverse remapping performing the inverse of the remapping process performed in the pre-encoding processing (101). The post-decoding processing can use metadata derived in the pre-encoding processing and signaled in the bitstream.

FIG. 7 illustrates a block diagram of an example of a system in which various aspects and embodiments are implemented. System 700 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 700, singly or in combination, can be embodied in a single integrated circuit (IC), multiple ICs, and/or discrete components. For example, in at least one embodiment, the processing and encoder/decoder elements of system 700 are distributed across multiple ICs and/or discrete components. In various embodiments, the system 700 is communicatively coupled to one or more other systems, or other electronic devices, via, for example, a communications bus or through dedicated input and/or output ports. In various embodiments, the system 700 is configured to implement one or more of the aspects described in this document.

The system 700 includes at least one processor 710 configured to execute instructions loaded therein for implementing, for example, the various aspects described in this document. Processor 710 can include embedded memory, input output interface, and various other circuitries as known in the art. The system 700 includes at least one memory 720 (e.g., a volatile memory device, and/or a non-volatile memory device). System 700 includes a storage device 740, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 740 can include an internal storage device, an attached storage device (including detachable and non-detachable storage devices), and/or a network accessible storage device, as non-limiting examples. System 700 includes an encoder/decoder module 730 configured, for example, to process data to provide an encoded video or decoded video, and the encoder/decoder module 730 can include its own processor and memory. The encoder/decoder module 730 represents module(s) that can be included in a device to perform the encoding and/or decoding functions. As is known, a device can include one or both of the encoding and decoding modules. Additionally, encoder/decoder module 730 can be implemented as a separate element of system 700 or can be incorporated within processor 710 as a combination of hardware and software as known to those skilled in the art.

Program code to be loaded onto processor 710 or encoder/decoder 730 to perform the various aspects described in this document can be stored in storage device 740 and subsequently loaded onto memory 720 for execution by processor 710. In accordance with various embodiments, one or more of processor 710, memory 720, storage device 740, and encoder/decoder module 730 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 710 and/or the encoder/decoder module 730 is used to store instructions and to provide working memory for processing that is needed during encoding or decoding. In other embodiments, however, a memory external to the processing device (for example, the processing device can be either the processor 710 or the encoder/decoder module 730) is used for one or more of these functions. The external memory can be the memory 720 and/or the storage device 740, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 700 can be provided through various input devices as indicated in block 705. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 6, include composite video.

In various embodiments, the input devices of block 705 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 700 to other electronic devices across USB and/or HDMI connections. It is to be understood that various aspects of input processing, for example, Reed-Solomon error correction, can be implemented, for example, within a separate input processing IC or within processor 710 as necessary. Similarly, aspects of USB or HDMI interface processing can be implemented within separate interface ICs or within processor 710 as necessary. The demodulated, error corrected, and demultiplexed stream is provided to various processing elements, including, for example, processor 710, and encoder/decoder 730 operating in combination with the memory and storage elements to process the data stream as necessary for presentation on an output device.

Various elements of system 700 can be provided within an integrated housing, Within the integrated housing, the various elements can be interconnected and transmit data therebetween using suitable connection arrangement 715, for example, an internal bus as known in the art, including the Inter-IC (12C) bus, wiring, and printed circuit boards.

The system 700 includes communication interface 750 that enables communication with other devices via communication channel 790. The communication interface 750 can include, but is not limited to, a transceiver configured to transmit and to receive data over communication channel 790. The communication interface 750 can include, but is not limited to, a modem or network card and the communication channel 790 can be implemented, for example, within a wired and/or a wireless medium.

Data is streamed, or otherwise provided, to the system 700, in various embodiments, using a wireless network such as a Wi-Fi network, for example IEEE 802.11 (IEEE refers to the Institute of Electrical and Electronics Engineers). The Wi-Fi signal of these embodiments is received over the communications channel 790 and the communications interface 750 which are adapted for Wi-Fi communications. The communications channel 790 of these embodiments is typically connected to an access point or router that provides access to external networks including the Internet for allowing streaming applications and other over-the-top communications. Other embodiments provide streamed data to the system 700 using a set-top box that delivers the data over the HDMI connection of the input block 705. Still other embodiments provide streamed data to the system 700 using the RF connection of the input block 705. As indicated above, various embodiments provide data in a non-streaming manner. Additionally, various embodiments use wireless networks other than Wi-Fi, for example a cellular network or a Bluetooth network.

The system 700 can provide an output signal to various output devices, including a display 765, speakers 775, and other peripheral devices 785. The display 765 of various embodiments includes one or more of, for example, a touchscreen display, an organic light-emitting diode (OLED) display, a curved display, and/or a foldable display. The display 765 can be for a television, a tablet, a laptop, a cell phone (mobile phone), or other device. The display 765 can also be integrated with other components (for example, as in a smart phone), or separate (for example, an external monitor for a laptop). The other peripheral devices 785 include, in various examples of embodiments, one or more of a stand-alone digital video disc (or digital versatile disc) (DVR, for both terms), a disk player, a stereo system, and/or a lighting system. Various embodiments use one or more peripheral devices 785 that provide a function based on the output of the system 700. For example, a disk player performs the function of playing the output of the system 700.

In various embodiments, control signals are communicated between the system 700 and the display 765, speakers 775, or other peripheral devices 785 using signaling such as AV.Link, Consumer Electronics Control (CEC), or other communications protocols that enable device-to-device control with or without user intervention. The output devices can be communicatively coupled to system 700 via dedicated connections through respective interfaces 765, 775, and 785. Alternatively, the output devices can be connected to system 700 using the communications channel 790 via the communications interface 750. The display 765 and speakers 775 can be integrated in a single unit with the other components of system 700 in an electronic device such as, for example, a television. In various embodiments, the display interface 765 includes a display driver, such as, for example, a timing controller (T Con) chip. The display 765 and speaker 775 can alternatively be separate from one or more of the other components, for example, if the RF portion of input 705 is part of a separate set-top box. In various embodiments in which the display 765 and speakers 775 are external components, the output signal can be provided via dedicated output connections, including, for example, HDMI ports, USB ports, or COMP outputs.

The embodiments can be carried out by computer software implemented by the processor 710 or by hardware, or by a combination of hardware and software. As a non-limiting example, the embodiments can be implemented by one or more integrated circuits. The memory 720 can be of any type appropriate to the technical environment and can be implemented using any appropriate data storage technology, such as optical memory devices, magnetic memory devices, semiconductor-based memory devices, fixed memory, and removable memory, as non-limiting examples. The processor 710 can be of any type appropriate to the technical environment, and can encompass one or more of microprocessors, general purpose computers, special purpose computers, digital signal processors (DSPs), and processors based on a multi-core architecture, as non-limiting examples.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application, for example, comprising obtaining, from the signaling, syntax elements that enable the decoder to apply high bit depth process, for instance related to the transform skip coding mode or the entropy coding using rice parameter.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application, for example, inserting in the signaling syntax elements that enables the decoder to apply high bit depth process in a manner corresponding to that used by the encoder, wherein the high bit depth process is for instance related to the transform skip coding mode or the entropy coding using rice parameter.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art. Note that the syntax elements as used herein, for example, sps_range_extension_flag, sps_range_extension . . . are descriptive terms. As such, they do not preclude the use of other syntax element names.

This disclosure has described various pieces of information, such as for example syntax, that can be transmitted or stored, for example. This information can be packaged or arranged in a variety of manners, including for example manners common in video standards such as putting the information into an SPS, a PPS, a NAL unit, a header (for example, a NAL unit header, or a slice header), or an SEI message. Other manners are also available, including for example manners common for system level or application level standards such as putting the information into one or more of the following:
SDP (session description protocol), a format for describing multimedia communication sessions for the purposes of session announcement and session invitation, for example as described in RFCs and used in conjunction with RTP (Real-time Transport Protocol) transmission;
DASH MPD (Media Presentation Description) Descriptors, for example as used in DASH and transmitted over HTTP, a Descriptor is associated to a Representation or collection of Representations to provide additional characteristic to the content Representation;
RTP header extensions, for example as used during RTP streaming;
ISO Base Media File Format, for example as used in OMAF and using boxes which are object-oriented building blocks defined by a unique type identifier and length also known as ‘atoms’ in some specifications;
HLS (HTTP live Streaming) manifest transmitted over HTTP. A manifest can be associated, for example, to a version or collection of versions of a content to provide characteristics of the version or collection of versions.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to rate distortion optimization. In particular, during the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of parameters for transform or rice parameter for entropy coding. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

We describe a number of embodiments. Features of these embodiments can be provided alone or in any combination, across various claim categories and types. Further, embodiments can include one or more of the following features, devices, or aspects, alone or in any combination, across various claim categories and types:
Adapting high bit depth process in the decoder and/or encoder.
Selecting high bit depth process to apply in the decoder and/or encoder.
Signaling an information relative to high bit depth process to apply in the decoder.
Deriving an information relative to a high bit depth process to apply from syntax elements, the deriving being applied in the decoder and/or encoder.
Inserting in the signaling syntax elements that enable the decoder to identify the high bit depth process to use, such as transform indices.
Selecting, based on these syntax elements, the at least one high bit depth process to apply at the decoder.
Applying the modified high bit depth process at the decoder.
A bitstream or signal that includes one or more of the described syntax elements, or variations thereof.
A bitstream or signal that includes syntax conveying information generated according to any of the embodiments described.
Inserting in the signaling syntax elements that enable the decoder to apply high bit depth process in a manner corresponding to that used by an encoder.
Creating and/or transmitting and/or receiving and/or decoding a bitstream or signal that includes one or more of the described syntax elements, or variations thereof.
Creating and/or transmitting and/or receiving and/or decoding according to any of the embodiments described.
A method, process, apparatus, medium storing instructions, medium storing data, or signal according to any of the embodiments described.
A TV, set-top box, cell phone, tablet, or other electronic device that performs a high bit depth process adapted to the signaling according to any of the embodiments described.
A TV, set-top box, cell phone, tablet, or other electronic device that performs a high bit depth process adapted to the signaling according to any of the embodiments described, and that displays (e.g. using a monitor, screen, or other type of display) a resulting image.
A TV, set-top box, cell phone, tablet, or other electronic device that selects (e.g. using a tuner) a channel to receive a signal including an encoded image, and performs a high bit depth process adapted to the signaling according to any of the embodiments described.
A TV, set-top box, cell phone, tablet, or other electronic device that receives (e.g. using an antenna) a signal over the air that includes an encoded image, and performs a high bit depth process adapted to the signaling according to any of the embodiments described.

1-4. (canceled)

5. An apparatus for video decoding, comprising one or more processors, wherein the one or more processors are configured to:
obtain video data, wherein the video data comprise at least one part of a coded picture, the coded picture being coded on a number of bits, and the video data further comprises an information that indicates whether at least one parameter related to high bit depth process is present in the video data for the coded picture;
wherein responsive to a determination that the number of bits on which the picture is coded is less than or equal to a level, the information indicates that the at least one parameter related to high bit depth process is not present in the video data for the coded picture.

6-16. (canceled)

17. A method for video decoding, comprising:
obtaining video data, wherein the video data comprise at least one part of a coded picture, the coded picture being coded on a number of bits called bit depth, and the video data further comprises an information that indicates whether at least one parameter related to high bit depth process is present in the video data for the coded picture;
wherein responsive to a determination that the number of bits on which the picture is coded is less than or equal to a level, the information indicates that the at least one parameter related to high bit depth process is not present in the video data for the coded picture.

18-43. (canceled)

44. A non-transitory computer readable medium comprising program code instructions to execute the decoding method of claim 17 when this program is executed on a computer.

45. (canceled)

46. An apparatus for video encoding, comprising one or more processors, wherein the one or more processors are configured to:
encode at least one part of a picture into video data, the picture being coded on a number of bits, and the video data further comprises an information that indicates whether at least one parameter related to high bit depth process is present in the video data for the picture being coded;
wherein responsive to a determination that the number of bits on which the at least one part of a picture is coded is less than or equal to a level, the information indicates that the at least one parameter related to high bit depth process is not present in the video data for the picture being coded.

47. A method for video encoding, comprising:
encoding at least one part of a picture into video data, the picture being coded on a number of bits, and the video data further comprises an information that indicates whether at least one parameter related to high bit depth process is present in the video data for the picture being coded;
wherein responsive to a determination that the number of bits on which the picture is coded is less than or equal to a level, the information indicates that the at least one parameter related to high bit depth process is not present in the video data for the picture being coded.

48. A non-transitory computer readable medium containing data content generated according to the method of claim 47.

49. A non-transitory computer readable medium comprising program code instructions to execute the encoding method of claim 47 when this program is executed on a computer.
